(19) United States
(12) Patent Application Publication
(10) Pub. No.: US 2013/0166450 A1
(43) Pub. Date: Jun. 27, 2013

(54) Identity Verification System Using Network Initiated USSD

(71) Applicant: Thandisizwe Ezwenilethu Pama, Lonehill (ZA)

(72) Inventor: Thandisizwe Ezwenilethu Pama, Lonehill (ZA)

(21) Appl. No.: 13/642,965

(22) PCT Filed: Apr. 26, 2011
(86) PCT No.: PCT/ZA2011/000027

§ 371 Date: Feb. 20, 2013

(30) Foreign Application Priority Data
Apr. 23, 2010 (ZA) 2010/02859
Apr. 30, 2010 (ZA) 2010/03011

(51) Int. Cl. G06Q 20/40; H04W 12/06

(52) U.S. Cl. CPC G06Q 20/40; H04W 12/06
USPC 705/44; 455/411

(57) ABSTRACT

The invention provides a method and means of authenticating a user in a communications session (such as an on-line payment) on a first communications channel (such as the Internet 12). In a preliminary step, data pertaining to the user and a user-operated mobile phone 24 is stored in a data store 18 that is in communication with the first communication channel. In this step, data uniquely associated with the phone SIM, preferably the SIM IMSI is recorded along with more general user data, including the mobile phone number or MS ISDN. The communications session triggers an out-of-band authentication of the communications session on a second channel established between the mobile phone 24 and the service provider 22 associated with the phone using network initiated Unstructured Supplementary Services Data (USSD). The USSD session is used to handle the out-of-band authentication process.

### FIELD OF THE INVENTION

This invention relates to the authentication of on-line Internet communications using out of band authentication.

### BACKGROUND TO THE INVENTION

The financial services industry has adopted the Internet as a service medium through the introduction of on-line banking, on-line payment and various other electronic financial services, all of which were initially designed for a trusted user operating from a trusted computer. As a result, the main security and access control measures for these systems rely on single factor authentication, which involves the use of identity credentials such as user names, passwords and personal identity numbers (PINs), that are provided or supplied in-band, that is within the same communications channel as the one on which the financial transaction is conducted.

Armed with keystroke logging software or simply by using phishing attacks, on-line criminals are often able to appropriate the identity credentials of entities involved in such on-line financial transactions with sufficient credibility for the system to allow the criminal to take over either or both the financial account and the transaction. Once the criminal gains access to personal identity data, in-band authentication systems are insufficient to differentiate between the real user and the criminal. The answer has been the use of out-of-band authentication, which requires the user to complete the transaction using a second network separate from the Internet connection used in the transaction. While any combination of separate networks is considered out-of-band authentication, the telephone network has emerged as the most familiar additional network available to the typical Internet user and with the almost ubiquitous use of mobile phones, on-line users are now likely to have a second, out-of-band network available to them no matter where they are communicating with their financial accounts.

The convenience and familiarity of SMS (Short Message Service) messaging has made this the typical out-of-band authentication mechanism. However, SMS suffers from the disadvantage that the messaging system is not secure and it can do no more than confirm the existence of a device—the mobile phone. It does not actually verify or authenticate the user. This is because the SMS message is sent to a phone supposedly associated with a transaction by directing the message to the mobile phone number, that is to the phone MSISDN (Mobile Subscriber Integrated Services Digital Network Number)—the number uniquely identifying the phone as a subscription in the GSM network—it is essentially the telephone number of the SIM (Subscriber Identity Module) card in the mobile phone.

The SIM is a piece of hardware and, by international agreement, each SIM is unique, having a unique “serial number” in the form of an IMSI (International Mobile Subscriber Identity), which is an important number for identifying a mobile subscriber. The IMSI identifies the SIM, that is the card inserted in to the mobile phone, while the MSISDN is used for routing calls to the phone. A SIM is uniquely associated with an IMSI, while the SIM MSISDN can change in time. For instance, a different MSISDN can be associated with the SIM through a number portability arrangement. SMS communication, on its own, is insufficient to include the use of the IMSI in an authentication process.

It is an object of this invention to provide a more secure out-of-band authentication system that is communicationally more secure and that is capable of including the IMSI in an authentication process.

### SUMMARY OF THE INVENTION

According to this invention, a method of authenticating a user in a communications session on a primary communications channel is provided, including, in a preliminary step, recording data in a data store associated with programmable logic means that is in communication with the primary communications channel, the data including data uniquely associated with the SIM in use in the mobile phone, the method comprising the steps of:
during the communications session on the primary communications channel, initiating an Unstructured Supplementary Services Data (USSD) communications session on the secondary communications channel between the programmable logic means and the user-operated mobile phone by way of the service provider associated with the phone, using USSD at least in the communication between the mobile phone and the service provider;
in the USSD communications session, transmitting a request for authentication data, including at least the data uniquely associated with the SIM card in use in the mobile phone, to the user-operated mobile phone;
transmitting the requested authentication data from the mobile phone to the programmable logic means and comparing the transmitted authentication data to the data pertaining to the user and the user-operated mobile phone stored in the data store; and
if the stored data correlates with the transmitted data, generating and transmitting an authorisation message authenticating the user.

The method may conveniently include the steps of, in the USSD communications session:
including in the transmitted request for authentication data, a request for the user to enter, on the mobile phone, a code previously communicated to the user and stored in the data store;
transmitting the code entered by the user to programmable logic means and comparing the transmitted code to the code recorded in the programmable logic means data store; and
preventing authorisation or authentication if the stored code fails to correlate with the transmitted code.

Alternatively or in addition, the method of may include the steps of:
in the USSD communications session on the secondary communications channel, transmitting a code to the user;
storing the the transmitted code for subsequent comparison;
in the communications session on the primary communications channel, transmitting a request for the user to enter, by way of the primary communications channel, the code transmitted to the user in the USSD communications session;
comparing the code entered by the user with the stored code transmitted to the user in the USSD communications session; and
preventing authorisation or authentication if the stored code fails to correlate with the transmitted code.

The communications session on the primary communications channel may be adapted automatically to initiate the USSD communications session on the secondary communications channel whilst the communications session on the primary communications channel is in progress, the method including the steps of not permitting the primary communications channel session to conclude successfully unless an authorisation message authenticating the user is generated within the USSD session.

The communications session on the primary communications channel will typically be an on-line financial transaction, but the invention is not limited to such an application and could be used in any on-line authentication system.

The on-line financial transaction may be a card transaction or a merchant payment transaction in which the communications session on the primary communications channel is initiated and conducted on a merchant's communications device (a POS terminal for instance) connected to the primary communications channel, the USSD session is conducted on the user-operated mobile phone and the authorisation message, which is adapted to authenticate the user and authorise the transaction is transmitted to the merchant's communications device (or POS terminal).

The invention includes an authentication system for authentication of a user in a communications session on a primary communications channel, the system comprising:
a data store associated with programmable logic means that is in communication with the primary communications channel to record data pertaining to the user and a user-operated mobile phone that is adapted to operate on a secondary communications channel, the data to be stored including data uniquely associated with the SIM in use in the mobile phone;
means to initiate, during the communications session on the primary communications channel, an Unstructured Supplementary Services Data (USSD) communications session on the secondary communications channel between the programmable logic means and the user-operated mobile phone by way of the service provider associated with the phone, using USSD at least in the communication between the mobile phone and the service provider;
the programmable logic means being programmed to generate and to transmit, in the USSD session, a request for authentication data, including at least the data uniquely associated with the SIM card in use in the mobile phone, to the user-operated mobile phone;
the mobile phone being pre-programmed to transmit the requested authentication data from the mobile phone to the programmable logic means;
the programmable logic means being programmed to compare the transmitted authentication data to the recorded data pertaining to the user and the user-operated mobile phone; and
the programmable logic means being programmed, if the stored data correlates with the transmitted data, to generate and transmit an authorisation message authenticating the user.

In one embodiment of the invention the programmable logic means may be programmed to generate and to transmit, in the USSD session and as part of the request for authentication data, a request for the user to enter, on the mobile phone, a code previously communicated to the user and stored in the programmable logic means data store, the phone being programmed to transmit the code entered by the user to the programmable logic means and the programmable logic means being programmed to compare the transmitted code to the code recorded in the data store and to prevent authorisation or authentication if the stored code fails to correlate with the transmitted code.

Alternatively or in addition, the programmable logic means may be programmed:
to generate and to transmit a code to the user in the USSD session and as part of the request for authentication data;
to store the the transmitted code for subsequent comparison;
in the communications session on the primary communications channel, to transmit a request for the user to enter, by way of the primary communications channel, the code transmitted to the user in the USSD communications session;
to compare the code entered by the user with the stored code transmitted to the user in the USSD communications session; and
if the stored code correlates with the transmitted code, to generate and transmit an authorisation message authenticating the user on the primary communications channel.

The invention includes a financial transaction processing and communications device (such as a POS terminal) as well as a mobile phone which are adapted, respectively for operation within the authentication system outlined above.

### BRIEF DESCRIPTION OF THE DRAWINGS

The invention will be further described with reference to the accompanying drawings in which:

FIG. 1 is a diagram illustrating a prior art out-of-band authentication system;

FIG. 2 is a diagram illustrating one embodiment of the the out-of-band authentication system of this invention; and

FIG. 3 is a diagram illustrating a further embodiment of the authentication system of this invention.

### DESCRIPTION OF EMBODIMENTS OF THE INVENTION

On-line banking originally relied on a trusted user operating from a trusted computer and it was thought that single factor authentication would be be adequate. However, as on-line banking fraud grew, it became apparent that stronger means of authentication are necessary, giving rise to the requirement for multi-factor authentication. This has given rise, in turn, to a variety of out-of-band authentication systems, one of the most common being the use of one-time passwords (OTPs) delivered by SMS and, because text messaging is a ubiquitous communication channel, being available in nearly all handsets and with a large customer-base, SMS messaging has a great potential to reach all consumers with a low total cost to implement. However, the SMS messaging system is insecure and open to criminal compromise. In addition to threats from criminals, the mobile phone network operator becomes part of the trust chain, which increases the opportunity for compromised network operator personnel to mount or assist in man-in-the-middle (MITM) attacks and other forms of unauthorised password acquisition.

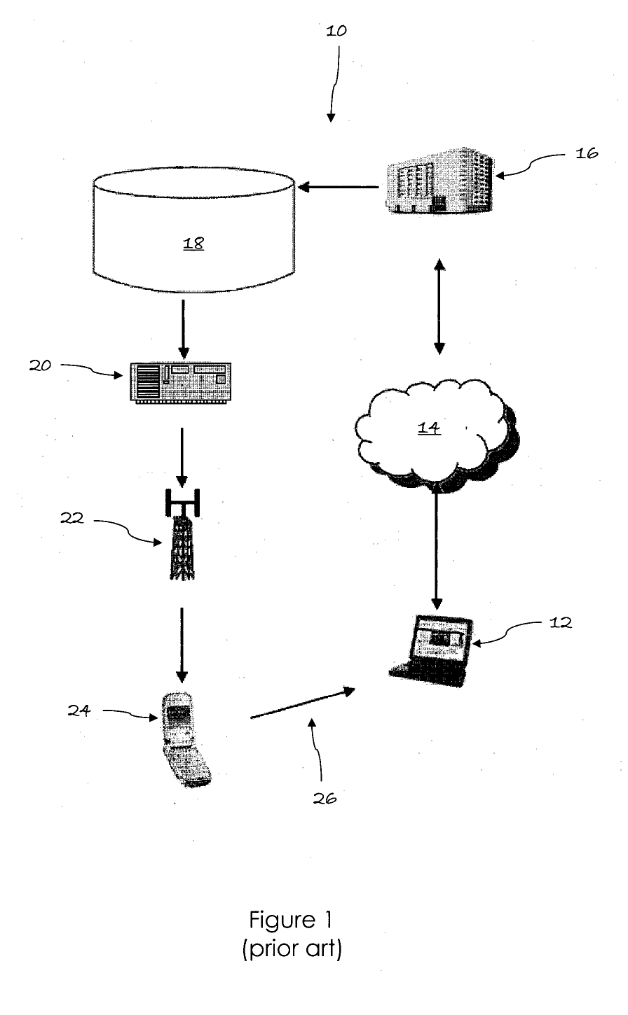

FIG. 1 shows the typical system 10 needed to process a prior art SMS-based transaction in which an on-line financial transaction request is processed on a personal computer 12 connected to the Internet 14, which constitutes the primary or in-band communications channel on which the transaction will be conducted and concluded. A bank 16 which is required to debit and credit the payment and recipient bank accounts of the authorised participating parties is connected to the primary, in-band channel by way of an Internet banking system that is implemented on a computer (not shown) that, besides being connected to the Internet 14, is also connected to an out-of-band authentication system 18. Certain details of the user of the PC 12 are recorded in the out-of-band authentication system 18, particularly the number of the mobile phone 24 that will be associated with the transactions to be undertaken by the user of the PC 12 by directing system-generated SMS messages to the phone number of the mobile phone 24, that is to the phone's MSISDN (Mobile Subscriber Integrated Services Digital Network Number). This is the number identifying the phone as a subscription in the GSM network of a mobile network operator 22 and is essentially the telephone number of the SIM (Subscriber Identity Module) card in the mobile phone.

When a transaction request is received from the PC 12, the bank computer processes the request and uses the out-of-band authentication system 18 to send an authorisation code (typically in the form of a one-time-password or OTP) by SMS to the phone 24. The user then enters the authorisation code (the OTP illustrated by means of the arrow 26) into the PC 12, which sends the OTP to the bank 16 by means of the Internet connection 14.

It will be appreciated that the prior art system 10 does not utilise true multi-factor authentication, nor does it fully overcome the problems posed by current mechanisms of unauthorised password acquisition. In addition, the authentication system 10 is logically incapable of confirming anything other than the transmission of an OTP originally sent out by the out-of-band authentication system 18 to a particular mobile phone number and the receipt of that OTP by the authentication system 10. The authentication system 10 relies entirely on the assumption that the recipient of the OTP is who they claim to be due to the fact that the OTP was sent to the mobile phone number stored in the out-of-band authentication system 18. In fact however, the out-of-band authentication system 108 is incapable of verifying the identity of the phone on which the OTP is received or the identity of the user operating the phone, or to raise an alarm in the event of the diversion or otherwise of the OTP to some other phone, which leaves the system wide open to fraudulent attack, particularly MITM attacks.

The out-of-band authentication system of this invention addresses these shortcomings by making use of network initiated Unstructured Supplementary Services Data (USSD) as the out-of-band communications channel. USSD is a communications protocol used by GSM cellular telephones to communicate with computers of their associated GSM service providers. Unlike Short Message Service (SMS) which uses a store-and-forward mode of data exchange, a real-time connection is created during a USSD session that remains open, allowing bidirectional data exchange. USSD Phase 2 as specified in GSM 03.90 supports network-initiated (“push”) operation and is the out-of-band communications protocol that is preferred for purposes of communications on the secondary channel that is used in the method and system of this invention.

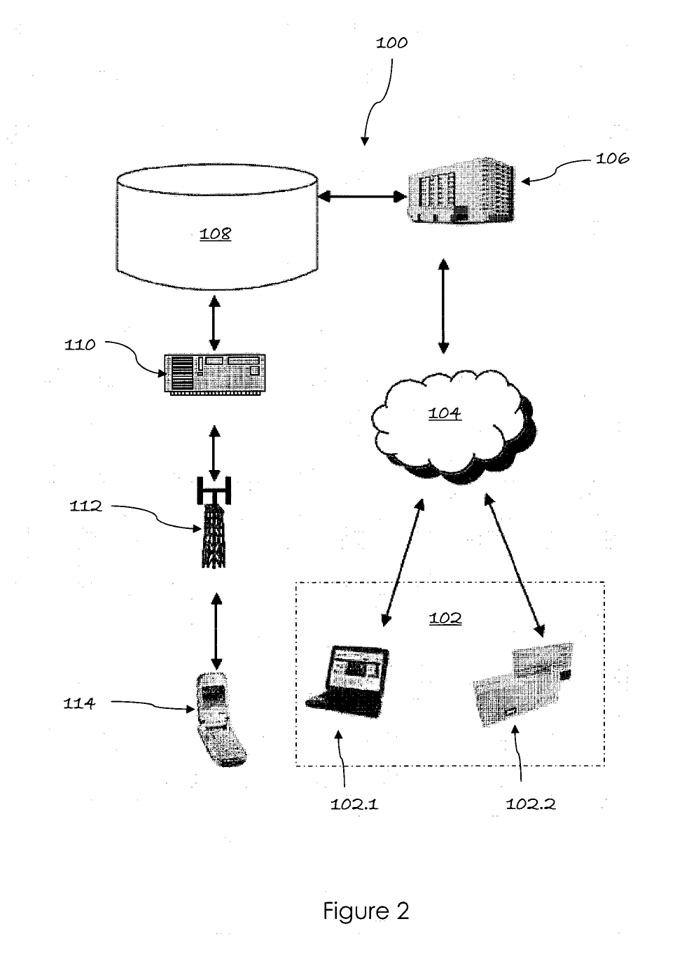

A first embodiment of the invention is shown in FIG. 2, which illustrates, in diagrammatic form, an out-of-band authentication system 100 on which an on-line financial transaction request is processed for a user (illustrated in block outline 102). Two transaction examples are illustrated, the first being an on-line payment or banking transaction conducted on a personal computer 102.1 connected to the Internet 104 by means of which the transaction details are communicated. The second transaction example is that of a bank debit or credit card transaction 102.2 (which may be a card-present or card-not-present transaction), which commences with the user 102, as cardholder, supplying her card 102.2 (or simply the card details in a card-not-present transaction) to a merchant or the like. The card details are communicated to the Internet 104, which constitutes the primary or in-band communications channel on which the transaction 102 will be conducted and concluded.

A bank 106 is connected to the primary, in-band channel 104 by way of an Internet banking system that is implemented on a computer (not shown) that is connected to the Internet 104 and to an out-of-band authentication system 108. Certain details of the user 102 are recorded at the bank or in the out-of-band authentication system 108 (preferably the latter) when the user 102 is first registered on the system, including the number (the MSISDN) of the mobile phone 114 that will be associated with the transactions to be undertaken by the user 102 and, more importantly, data uniquely associated with the SIM in use in the mobile phone 114, particularly the IMSI which uniquely identifies the SIM card that is intended to be in use in the mobile phone 114 during normal, uncompromised operation thereof.

When the transaction request is received from the user 102, the bank computer 106 processes the request and uses the out-of-band authentication system 108 to initiate and conduct a USSD communications session, by way of a network-initiated USSD (NI USSD) gateway 110 under the control of the out-of-band authentication system 108 and in communication with the mobile network operator 112 associated with the phone 114. The USSD communications session is a network-initiated or “push” operation and opens on a communications channel that is secondary to the primary or Internet communications channel 104.

By means of the NI USSD gateway 110, the USSD session is kept open for a bidirectional data exchange in which the out-of-band authentication system 108 transmits a request for authentication data to the phone 114, including at least the SIM card IMSI in use in the phone 114. In the user registration process, the phone 114 is loaded with a software application that programs the phone 114 to respond appropriately to the data request, so that the phone transmits the requested authentication data, including the IMSI to the out-of-band authentication system 108, which compares the authentication data it receives from the phone 114 to the user data stored in the out-of-band authentication system 108.

If the received data (as transmitted by the phone 114) correlates with the user data stored in the out-of-band authentication system 108, the system will generate and transmit an authorisation message and close the USSD session.

The authorisation message could be an OTP sent to the phone 114 within the USSD session or it could be a message or code authenticating the user and authorising the transaction that is sent on the primary communications channel, that is by way of the Internet, to the merchant or bank that requires the authorisation and verification of the transaction.

A user password-entry step may be added into the system 100 to increase the authentication factor. To this end, the user password-entry step may use a previously provided password or a new OTP generated during the course of the authentication session. In addition, the user password-entry procedure can be included in the USSD session or it can be conducted over the primary channel. In one example of a password-entry procedure, the out-of-band authentication system 108 is programmed to transmit, in the USSD communications session, a request or prompt to the user to enter, on the mobile phone 114, a previously provided password, typically a code or password communicated to the user in the user registration process and stored in the out-of-band authentication system 108. The phone 114 is programmed to transmit the password entered by the user to the out-of-band authentication system 108, which compares the received password to the password recorded in the out-of-band authentication system 108 in respect of the user 102. In another example, the password-entry procedure is effected by the out-of-band authentication system 108 generating and storing an OTP and transmitting the OTP to the user 102 in the USSD session on the secondary communications channel. The phone is programmed to prompt the user 102 to enter the OTP. This can be done on either communications channel, either by entering the OTP on the phone 114 for communication of the OTP to the out-of-band authentication system on the out-of-band channel or by entering the OTP on the primary (Internet 104) channel, using the PC 102.1 or the device used in the card transaction 102.2.

In each case, the system 100 (preferably the out-of-band authentication system 108) compares the password or code so entered by the user with the password or code stored in the out-of-band authentication system 108 (either during user registration or when generating the OTP). The system 100 is programmed to prevent authentication of the user or authorisation of the transaction if the stored code fails to correlate with the transmitted code entered by the user 102.

It will be seen that the USSD session is entirely network-initiated, in that the system 100 is programmed to react to the communications session on the primary communications channel (PC 102.1/card transaction 102.2; Internet 104; bank 106 and out-of-band authentication system 108), automatically to initiate the USSD communications session on the secondary communications channel (out-of-band authentication system 108; NI USSD gateway 110; mobile network operator 112; phone 114 and to hold the USSD session open whilst the communications session on the primary communications channel is in progress. The system 100 is programmed to not permit the primary communications channel session to conclude successfully (that is by authenticating the user or the transaction) unless the USSD authorisation session is concluded successfully, the system 100 being programmed to prevent authentication of the user or authorisation of the transaction if the codes or passwords required in the USSD session fail to correlate.

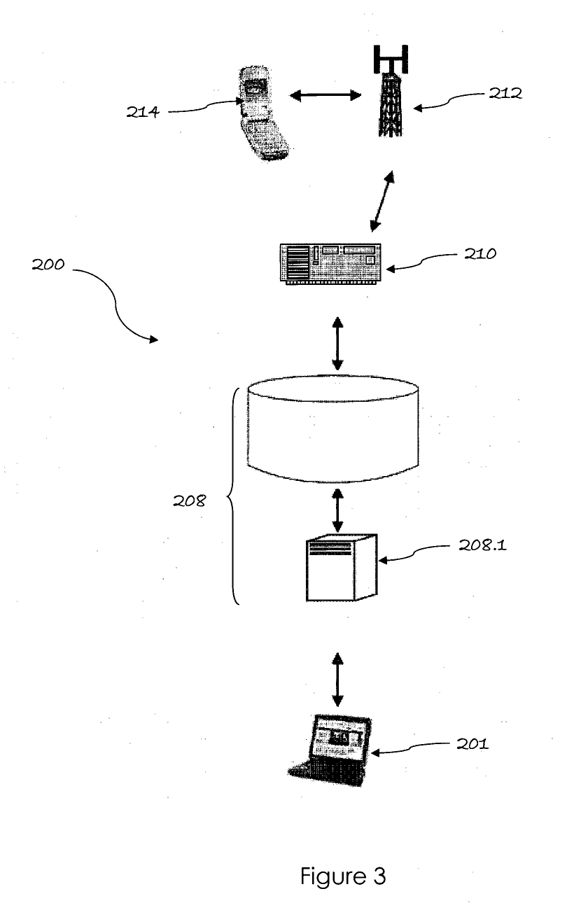

A second embodiment of the invention is shown in FIG. 3, which illustrates, in diagrammatic form, an out-of-band authentication system 200 on which a merchant or retailer payment request is being processed, typically by means of a retailer POS terminal 201 connected to the Internet or some other form of telecommunications, which constitutes the primary or in-band communications channel on which the transaction will be conducted and concluded. A bank (not shown) is included in the connected to the primary, in-band channel by way of an Internet banking system. When the transaction request is received from the user POS terminal 201, the request is routed through an out-of-band authentication system 208 that is programmed to initiate and conduct a USSD communications session, by way of a network-initiated USSD (NI USSD) gateway 210 that is under the control of the out-of-band authentication system 208 and in communication with the mobile network operator 212 associated with the phone 214 of the user making the payment on the POS terminal 201. The USSD communications session is a network-initiated operation and opens on a communications channel that is secondary to the primary or Internet communications channel 104.

The USSD session is kept open for a bidirectional data exchange in which the out-of-band authentication system 208 transmits a request for authentication data to the phone 214, including the SIM card IMSI in use in the phone 214. The phone transmits the requested authentication data, including the IMSI to the out-of-band authentication system 208, which compares the authentication data it receives from the phone 214 to user data stored in a user MSISDN and IMSI database 208.1. If the received data (as transmitted by the phone 114) correlates with the user data stored in the out-of-band authentication system 108, the out-of-band authentication system 208 generates and transmits, to the phone 214, an authorisation message in the form of an OTP. This is done within the USSD session, which closes down once the OTP has been sent to the phone. The user can then enter the OTP into the POS terminal 201 to authorise the payment. The authorisation message could also be a message or code authenticating the user and authorising the transaction that is sent on the primary communications channel, that is by way of the Internet, to the POS terminal 201.

The system offers numerous security benefits, one being the fact that there is no need for the financial services provider to send confidential security information over an insecure system. In addition, being interactive, the system of the invention allows the development of interactive query processes in which a user may be prompted to supply additional details that may be required to verify the authenticity of the user.

Also, the system allows real time processing, with all the benefits appertaining thereto.

Since the system is triggered by user activity, this means that a user will only receive a request to participate in a USSD session when engaging in a transaction, which is very different from the unsolicited advertisements and proposals that have made push technology unacceptable and which have prevented greater use of network-initiated USSD. This also means that any USSD session received outside of the user engaging in a user-initiated transaction is not legitimate and is either a fraudulent transaction or an unsolicited “pushed” advertisement.

The system allows an account holder to be verified, with a high degree of confidence, as being present and approving of the transaction in question.

What is claimed is:

1. A method of authenticating a user in a communications session on a primary communications channel, including, in a preliminary step, recording data in a data store associated with programmable logic means that is in communication with the primary communications channel, the data including data uniquely associated with a SIM in use in the mobile phone, the method comprising:
during the communications session on the primary communications channel, initiating an Unstructured Supplementary Services Data (USSD) communications session on a secondary communications channel between the programmable logic means and the user-operated mobile phone by way of the service provider associated with the phone, using USSD at least in the communication between the mobile phone and the service provider;
in the USSD communications session, transmitting a request for authentication data, including at least the data uniquely associated with the SIM in use in the mobile phone, to the user-operated mobile phone;
transmitting the requested authentication data from the mobile phone to the programmable logic means and comparing the transmitted authentication data to the data pertaining to the user and the user-operated mobile phone stored in the data store; and
if the stored data correlates with the transmitted data, generating and transmitting an authorization message authenticating the user.

2. The method of claim 1, further comprising, in the USSD communications session:
including in the transmitted request for authentication data, a request for the user to enter, on the mobile phone, a code previously communicated to the user and stored in the data store;
transmitting the code entered by the user to programmable logic means and comparing the transmitted code to the code recorded in the programmable logic means data store; and
preventing authorization or authentication if the stored code fails to correlate with the transmitted code.

3. The method of claim 1, further comprising:
in the USSD communications session on the secondary communications channel, transmitting a code to the user;
storing the transmitted code for subsequent comparison;
in the communications session on the primary communications channel, transmitting a request for the user to enter, by way of the primary communications channel, the code transmitted to the user in the USSD communications session;
comparing the code entered by the user with the stored code transmitted to the user in the USSD communications session; and
preventing authorization or authentication if the stored code fails to correlate with the transmitted code.

4. The method of claim 1, wherein the communications session on the primary communications channel is adapted automatically to initiate the USSD communications session on the secondary communications channel while the communications session on the primary communications channel is in progress.

5. The method of claim 1, wherein the communications session on the primary communications channel is an on-line financial transaction.

6. The method of claim 5, wherein the on-line transaction is a merchant payment transaction and the communications session on the primary communications channel is initiated and conducted on a merchant's communications device connected to the primary communications channel, the USSD session is conducted on the user-operated mobile phone and the authorization message, which is adapted to authenticate the user and authorize the transaction, is transmitted to the merchant's communications device.

7. The method of claim 5, wherein the on-line financial transaction is a card transaction.

8. An authentication system for authentication of a user in a communications session on a primary communications channel, the system comprising:
a data store associated with programmable logic means that is in communication with the primary communications channel to record data pertaining to the user and a user-operated mobile phone configured to operate on a secondary communications channel, the data to be stored including data uniquely associated with a SIM in use in the mobile phone;
means to initiate, during the communications session on the primary communications channel, an Unstructured Supplementary Services Data (USSD) communications session on the secondary communications channel between the programmable logic means and the user-operated mobile phone by way of the service provider associated with the phone, using USSD at least in the communication between the mobile phone and the service provider;
the programmable logic means being configured to generate and to transmit, in the USSD session, a request for authentication data, including at least the data uniquely associated with the SIM in use in the mobile phone, to the user-operated mobile phone;
the mobile phone being pre-configured pre-programmed to transmit the requested authentication data from the mobile phone to the programmable logic means;
the programmable logic means being configured to compare the transmitted authentication data to the recorded data pertaining to the user and the user-operated mobile phone; and
the programmable logic means being configured, if the stored data correlates with the transmitted data, to generate and transmit an authorization message authenticating the user.

9. The authentication system of claim 8, wherein the programmable logic means is configured to generate and to transmit, in the USSD session and as part of the request for authentication data, a request for the user to enter, on the mobile phone, a code previously communicated to the user and stored in the programmable logic means data store, the phone being configured to transmit the code entered by the user to the programmable logic means and the programmable logic means being configured to compare the transmitted code to the code recorded in the data store and to prevent authorization or authentication if the stored code fails to correlate with the transmitted code.

10. The authentication system of claim 8, wherein the programmable logic means is configured:
to generate and to transmit a code to the user in the USSD session and as part of the request for authentication data;
to store the transmitted code for subsequent comparison;
in the communications session on the primary communications channel, to transmit a request for the user to enter, by way of the primary communications channel, the code transmitted to the user in the USSD communications session;
to compare the code entered by the user with the stored code transmitted to the user in the USSD communications session; and
to prevent authorization or authentication if the stored code fails to correlate with the transmitted code.

11. The authentication system of claim 8, wherein the programmable logic means is configured to automatically initiate the USSD communications session on the secondary communications channel while the communications session on the primary communications channel is in progress and to preclude the primary communications channel session from concluding successfully unless an authorization message authenticating the user is received on the primary communications channel.

12. The authentication system of claim 8, further comprising a financial transaction processing and communications device configured for connection to the primary communications channel and to initiate and conduct the communications session on the primary communications channel, the programmable logic means being configured to conduct the USSD session on the user-operated mobile phone and to transmit the authorization message, which is intended to authenticate the user and authorize the transaction, to the financial transaction processing and communications device.

13. (canceled)

14. (canceled)

15. The method of claim 4, further comprising:
preventing the primary communications channel session from successfully concluding unless an authorization message authenticating the user is received on the primary communications channel.

16. An authentication system for authentication of a user in a merchant payment transaction on a primary communications channel, the system comprising:
a data store associated with programmable logic means that is in communication with the primary communications channel to record data pertaining to the user and a user-operated mobile phone configured to operate on a secondary communications channel, the data to be stored including data uniquely associated with a SIM in use in the mobile phone;
means to initiate, during the communications session on the primary communications channel, an Unstructured Supplementary Services Data (USSD) communications session on the secondary communications channel between the programmable logic means and the user-operated mobile phone by way of the service provider associated with the phone, using USSD at least in the communication between the mobile phone and the service provider;
a merchant communications device configured for connection to the primary communications channel and to initiate and conduct the communications session on the primary communications channel;
the programmable logic means being configured to conduct the USSD session on the user-operated mobile phone and to generate and transmit, in the USSD session, a request for authentication data, including at least the data uniquely associated with the SIM in use in the mobile phone, to the user-operated mobile phone;
the mobile phone being pre-configured to transmit the requested authentication data from the mobile phone to the programmable logic means;
the programmable logic means being configured to compare the transmitted authentication data to the recorded data pertaining to the user and the user-operated mobile phone, and, if the stored data correlates with the transmitted data, to generate and transmit an authorization message authenticating the user and authorizing the transaction to the merchant communications device.

17. The authentication system of claim 16, wherein the programmable logic means is configured to generate and to transmit, in the USSD session and as part of the request for authentication data, a request for the user to enter, on the mobile phone, a code previously communicated to the user and stored in the programmable logic means data store.

18. The authentication system of claim 17, wherein the phone is configured to transmit the code entered by the user to the programmable logic means and the programmable logic means is configured to compare the transmitted code to the code recorded in the data store and to prevent authorization or authentication if the stored code fails to correlate with the transmitted code.

19. The authentication system of claim 16, wherein the programmable logic means is configured to:
generate and to transmit a code to the user in the USSD session and as part of the request for authentication data;
store the transmitted code for subsequent comparison;
in the communications session on the primary communications channel, transmit a request for the user to enter, by way of the primary communications channel, the code transmitted to the user in the USSD communications session;
compare the code entered by the user with the stored code transmitted to the user in the USSD communications session; and
prevent authorization or authentication if the stored code fails to correlate with the transmitted code.

20. The authentication system of claim 16, wherein the programmable logic means is configured to automatically initiate the USSD communications session on the secondary communications channel while the communications session on the primary communications channel is in progress.

21. The authentication system of claim 20, wherein the programmable logic means is further configured to preclude the primary communications channel session from concluding successfully unless an authorization message authenticating the user is received on the primary communications channel

22. The authentication system of claim 16, wherein the merchant payment transaction is a card transaction
